(19) United States
(12) Patent Application Publication
(10) Pub. No.: US 2014/0199458 A1
(43) Pub. Date: Jul. 17, 2014

(54) "Le Four en Brique" - The first brick oven designed for your oven

(71) Applicant: Faheem Chanda, Oakland, CA (US)

(72) Inventor: Faheem Chanda, Oakland, CA (US)

(21) Appl. No.: 13/740,352

(22) Filed: Jan. 14, 2013

(51) Int. Cl. A47J 36/04; A47J 37/01

(52) U.S. Cl. CPC A47J 36/04; A47J 37/01
USPC 426/523; 220/573.1

(57) ABSTRACT

An apparatus and method to temporarily convert an oven into a brick oven comprising a dome with a ventilation aperture governed by a damper to control the accumulation of hot air within the dome, and a plate placed within the dome possessing a diameter less than the diameter dome to permit heat to rise up from within the oven into the dome. A handle is secured to the dome to facilitate handling of the dome.

### RELATED APPLICATION

This application claims priority to provisional patent application U.S. Ser. No. 61/586871 filed on Jan. 16, 2012, the entire contents of which is herein incorporated by reference.

### FIELD OF INNOVATION

The present invention relates generally to an apparatus that improves the cooking experience for any person preparing meals with a standard home oven.

Currently there are few solutions for high temperature cooking available for semi-professional chefs, amateur cooks and homemakers outside of a restaurant setting. Some of these solutions attempt to provide the same characteristics as a traditional brick oven, or wood fired oven, but these solutions fail to meet the needs of the above mentioned because they require a significant amount of space and are immobile in nature. Other solutions attempt to concentrate heat to provide the adequate temperature to cook various kinds of foods, but these solutions are similarly unable to meet the needs of the industry because they are impractical. For example, they require many hours for the heat to generate and concentrate as well as require an environmentally unfriendly energy source such as wood or coal to generate this heat. Still other solutions seek to meet this requirements for the above mentioned, but these solutions also fail to meet industry needs because they are very hard to install, very expensive to maintain and finally can only be used if one has a large back yard or patio area.

It would be desirable to have an apparatus that can provide the same benefits for the above mentioned that can be used to prepare gourmet quality pizza, breads, meats, poultry and seafood as one can with a traditional brick oven in a restaurant. Furthermore, it would also be desirable to have an apparatus that is mobile, easy to store and can be used in any standard oven thus at home irrespective if the home has a yard to accommodate a brick oven. Still further, it would be desirable to have an apparatus that can prepare such foods without requiring coal to generate the heat, or a high installation costs and is easy to clean after use. Therefore, there currently exists a need in the industry for a composition that can provide the same cooking effect as a traditional brick oven or wood fired oven that fits in a standard home oven.

### SUMMARY OF THE INVENTION

The present invention advantageously fills the aforementioned deficiencies by providing an apparatus that mimics the environment provided by a brick oven for such cooking purposes. This invention can be described as a brick oven designed to fit in a person's home oven.

The present invention is a device that improves the ability of a cook to achieve similar cooking conditions of a brick oven inside one's home oven. The shape and function of this device mimics the cooking environments of a brick oven to provide the perfect temperature and environment to cook pizza's, breads, poultry, meats, stews among other food items. Embodiments of the apparatus consists of five major components—the dome itself, the plate, the handle, the ventilation system (which is part of the handle) and the Chanda Home emblem. Besides the plate, the handle and emblem are bolted onto the dome for handling and aesthetic purposes respectively. The vent which is part of the handle, controls the amount of heat that is allowed to pass through the dome. The dome is the central and most important piece of the system. The plate can be used to cook any kind of food—pizza's, breads, meats, pastries and more. The plate is designed to enter the mouth of the dome easily and be used on both sides (one side for meats, the other for breads/pizza's). The handle has been designed with functional, design and aesthetics in mind. The combined effect of the all the components offer a completely unique cooking experience.

The present invention may also have one or more of the following items: pizza plate, dome holder, plate with 3 sections for cooking, baking plate and meat plate (this plate has a 2 inch lip). All of the above are made from natural clay and are designed with specific requirements in mind to work in conjunction with the dome.

The embodiments of the apparatus miniaturizes the effects of a standard brick oven. It requires very little space, it uses your oven as its main heat source, heats up very quickly, it is very mobile and very flexible in terms of its use cases—any kind of food, in an oven or on a barbeque. Finally all the associated components maximize its functionality.

The present invention is unique in that it is structurally different from other known devices or solutions. More specifically, the present invention is unique due to the presence of: (1) design and functionality—fits in an oven and provides the same effect as a large brick oven; (2) does not require any coal to generate the I heat, it uses an oven-(3) is very light and mobile. It is still further an object that is significantly less costly than a brick oven and can be used by anyone that has an oven in their home with ease.

The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 shows a perspective view of the present invention;

FIG. 2 shows a perspective view of the embodiment of FIG. 1 in use in a conventional oven;

FIG. 3 shows a perspective view of one of the embodiments of the ventilation system employed in embodiments of the present invention.

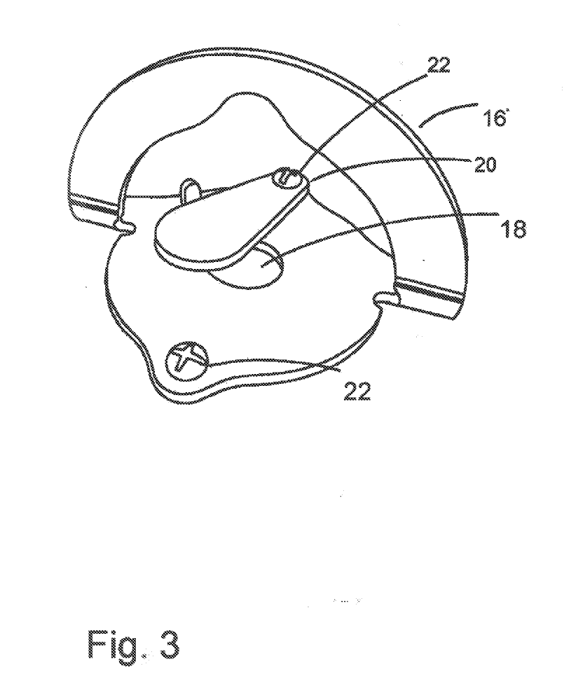

### DETAILED DESCRIPTION OF THE INVENTION

The present invention (10) can be described as a brick oven designed to fit in a person's home oven (20). The unique attribute of embodiments of the apparatus enables the home chef to trap concentrated heat in the dome to improve the cooking process for any kind of food. By leveraging the heat generated from the oven or a barbeque, the dome (12) captures this heat and offers a much higher temperature inside the dome. This heat accelerates the cook time for foods such as pizza's, breads, meats and more. The ability to trap this heat takes place as follows.

Since the size of the plate (14) is smaller than the dome (12) and since the plate (14) fits inside the dome (12), resulting in a gap there is a space between the end of the plate (14) and the dome (12). This space is a key component of the design as this space to enables heat to pass and rise into the dome (12). Once the heat is inside the dome, it does not escape from the dome unless the vent (20) is adjusted to pass more air. The bigger the size of the vent, then the more heat will pass through. The thickness of the dome also plays a significant part in created the right cooking dynamics. Thus once the heat starts to pass through, the dome (12) stores this trapped heat and bounces the heat back onto the food, further creating an ideal environment for cooking high quality foods. The mouth aperture of the dome (into which the plate is placed) is also designed to trap as much heat as possible and designed to enable the user the take the plates out easily.

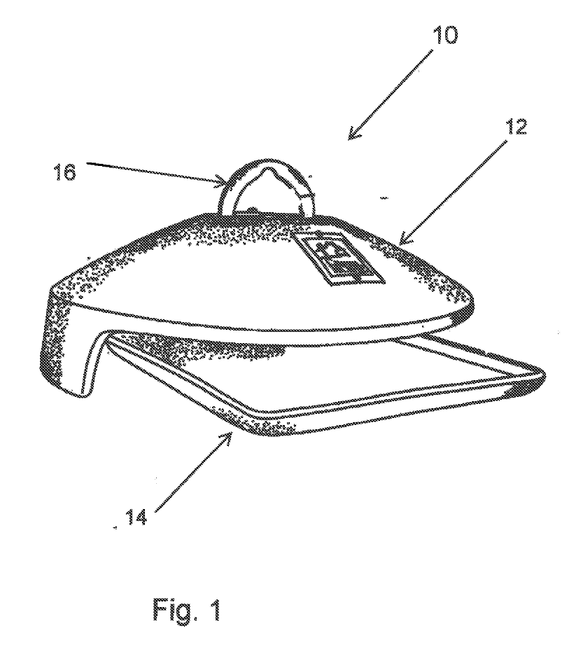

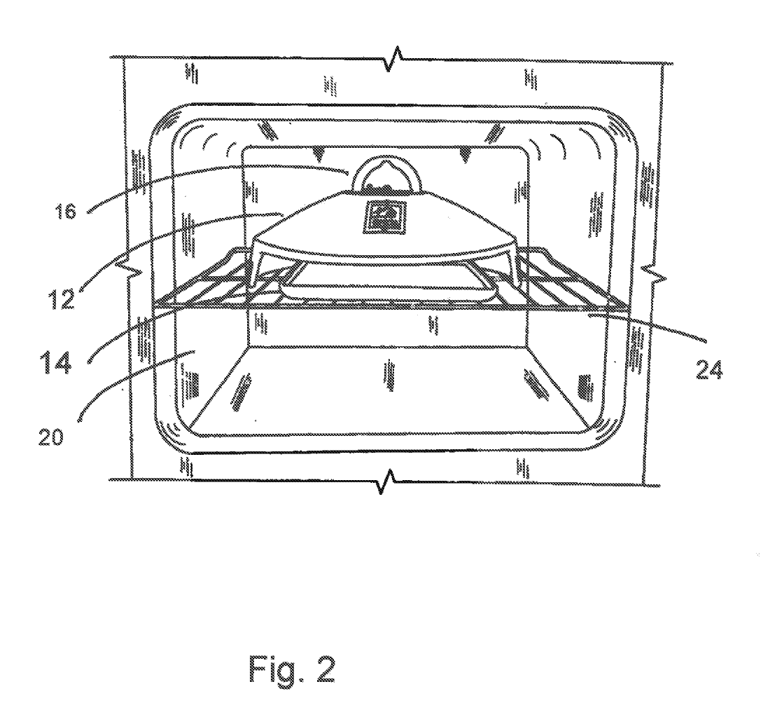

Referring to the figures, FIG. 1 shows the present invention (10) and it's components. FIG. 2 shows how the heat is trapped inside the dome (12) inside a standard home oven (24).

The present invention is a device that improves the ability of a cook to achieve similar cooking conditions of a brick oven inside one's home oven. The shape and function of this device mimics the cooking environments of a brick oven to provide the perfect temperature and environment to cook pizza's, breads, poultry, meats, stews among other food items. Embodiments of the apparatus consists of five major components—the dome itself (12), the plate (14), the handle (16), the ventilation system (18, 20) (which is part of the handle (16, 22)) and the Chanda Home emblem. Besides the plate (14), the handle (14) and emblem are bolted (22) onto the dome (12) for handling and aesthetic purposes respectively. The vent (20), which is part of the handle (16), controls the amount of heat that is allowed to pass through the dome (12). The dome (12) is the central and most important piece of the system (10). The plate (14) can be used to cook any kind of food—pizza's, breads, meats, pastries and more. The plate (14) is designed to enter the-mouth of the dome (12) easily and be used on both sides (one side for meats, the other for breads/pizza's). The handle (16) has been designed with functional, design and aesthetics in mind. The combined effect of the all the components offer a completely unique cooking experience.

While the present invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

1-13. (canceled)

14. A system configured to simulate the cooking environment of a brick oven within the confines of a conventional cooking environment, the system comprising:
a plate fabricated from high temperature resistant material comprising a predefined area and having a top surface suitable for heating food in a high temperature environment;
a generally dome shaped cover comprising a semicircular annular wall that defines an opening into which the plate may be inserted and removed, the cover comprising high temperature resistant material, the annular wall having a diameter that defines a surface area larger than the predefined area of the plate, wherein when the plate is inserted within the opening a gap is defined by the interior top of the dome and top surface of the plate to define a cooking environment that helps to simulate a brick oven; and
a ventilator provided at or proximal to the center of the dome shaped cover, the ventilator comprising an aperture in the cover and a damper to control the amount of air flow between the interior of the cover and the exterior of the cover for purposes of controlling the heating environment within the system;
wherein when the system is provided with food on the plate and inserted within a conventional cooking environment the food may be heated and cooked in a manner that results in the food having the appearance and taste of being cooked within a brick oven.

15. The system of claim 14 further comprising a handle attached to the dome shaped cover to facilitate placement of the dome shaped cover within a conventional cooking environement.

16. A method for converting a conventional heat cooking environment into a brick oven, the method comprising:
providing the system of claim 14;
placing said dome shaped body into the conventional cooking environment;
placing food onto the plate;
inserting the plate into the opening of the dome shaped cover; and actuating the conventional heat to cook the food in a manner so as to simulate cooking within a brick oven.
